(19) United States
(12) Patent Application Publication
(10) Pub. No.: US 2018/0018289 A1
(43) Pub. Date: Jan. 18, 2018

(54) Method for Recognizing Software Applications and User Inputs

(71) Applicants: Stephan Preussler, Alfter (DE); Alexander Van Laack, Aachen (DE); Stephan Kuhn, Frechen (DE)

(72) Inventors: Stephan Preussler, Alfter (DE); Alexander Van Laack, Aachen (DE); Stephan Kuhn, Frechen (DE)

(21) Appl. No.: 15/663,436

(22) Filed: Jul. 28, 2017

(30) Foreign Application Priority Data
Jul. 13, 2016 (DE) 10 2016 112 833.3

(51) Int. Cl. G06F 13/10; G06F 13/20

(52) U.S. Cl. CPC G06F 13/102; G06F 13/20

(57) ABSTRACT

The underlying aim of the disclosure, which relates to a method for recognizing software applications and user inputs is to indicate a solution by a recognition of a software application currently implemented by the user as well as inputs that have been made is made possible without additional interfaces provided by manufacturers of car operating systems. The aim is achieved in that the data decoded in the signal decoder is subjected to a first analysis, in which, by means of data stored in a database, an association of the decoded data with a known software application occurs.

### CROSS-REFERENCE TO RELATED APPLICATIONS

This application claims priority to German Patent Application No. 10 2016 112 833.3 filed Jul. 13, 2016 and entitled “METHOD FOR RECOGNIZING SOFTWARE APPLICATIONS AND USER INPUTS,” which is herein incorporated by reference.

### BACKGROUND

The disclosure relates to a method for recognizing software applications and user inputs, wherein for data transfer external unit is connected via an interface to a control unit of a motor vehicle, wherein a car operating system is implemented by the control unit and wherein the data transferred by the external unit is decoded in a signal decoder and displayed.

The disclosure relates in particular to the determination and evaluation of implemented software applications and user interactions in the motor vehicle via a control unit, such as a vehicle infotainment system with its own car operating system, referred to in short as “CarOS.”

From the prior art, there are known technologies for connecting external units and devices such as a smartphone, a tablet or a laptop to a central control unit in a motor vehicle. Such a control unit can be, for example, a vehicle infotainment system which combines, in a motor vehicle, functionalities of several systems such as a car radio, a navigation system, a driver assistance system, an on-board computer or a hands-free speaker phone.

Usually, a wire or wireless connection is established between the external unit and the control unit. Here, for example, transfer protocols such as “Universal Serial Bus,” abbreviated USB, “FireWire,” “Bluetooth,” “Wi-Fi,” and others are used.

In such couplings, it is possible to control functions of the external unit via operating elements of a vehicle infotainment system, a sound system or a navigation system arranged in the motor vehicle. For this purpose, the surfaces of such systems, which usually are provided with touch sensors, or associated operating elements such as keys, buttons or wheels and others can be used. An input or control by speech input is also possible.

Known systems or methods which enable such a coupling of external devices to a control unit incorporated in a motor vehicle include “Mirrorlink,” “Android Auto” from Google and “CarPlay” from Apple. The systems have their own operating system, also referred to as “OS” for “Operating System,” which is also referred to as car operating system.

According to a connection structure, for example, sound data, video data or text data is transmitted from a smartphone as external device to the control unit and represented via the control unit in an appropriate display. In addition, it is usually provided to transmit the user input or feedback of the control unit to the external device such as the smartphone.

Self-driving motor vehicles are also known from the prior art, which are also referred to autonomous vehicles and which are capable of driving and parking without the intervention of a vehicle driver. The autonomous motor vehicles are able to perceive, with the aid of different sensors, the environment thereof and to determine from the information obtained the position thereof and the position of other traffic participants. Here, it becomes possible to reach a predetermined travel destination, for example, using a navigation software integrated in the motor vehicle. In addition, in the destination guidance, such systems can recognize collisions and avoid them by appropriate measures.

From DE 10 2015 113 063 A1, a system and a method for supporting the connectivity of a mobile terminal with a motor vehicle are known. For this purpose, a mobile terminal is provided, which is designed with at least one connectivity option for connection to a communication channel of the motor vehicle. A flexible connectivity module which comprises a controller is programmed in order to determine whether, between the mobile terminal and the motor vehicle, there is at least one appropriate communication channel, so that the mobile terminal and the motor vehicle can be in connection with one another. If more than one of the appropriate communication channels is available, the controller selects the optimal connectivity option, monitors the selected connectivity option, and changes or modifies the selected connectivity option when a predetermined interference threshold is reached.

Although applications such as “CarPlay” and “Android Auto” provide a possibility of using a vehicle display in order to project the monitor of an electronic device, such as a smartphone, in the motor vehicle, there is a need in the technology for a possibility of determining the best connectivity option available between the motor vehicle and the smartphone as external device in order to ensure a projection of best quality.

For this purpose, it is provided to copy or to mirror the monitor of a smartphone on display present in the motor vehicle. Such a display is, for example, any display which can also be part of an infotainment installation of the motor vehicle.

The vehicle communication architecture described in DE 10 2015 113 063 A1 is designed with an audio/video forward channel, a control feedback channel, a transfer control protocol/user datagram protocol, abbreviated TCP/UDP, an Internet protocol, abbreviated IP, and a flexible connectivity module.

The control feedback channel comprises a user input back channel, abbreviated UIBC, and an audio feedback channel, abbreviated ABC, which enable a user to provide commands, for example, via touchscreen events or: keyboard events by using the user input feedback channel and/or microphone events by using the audio feedback channel.

If there is a possibility for selection from two or more connection possibilities between the external device, such as the smartphone, and the motor vehicle, the algorithm automatically selects a preferred interface.

As soon as a session has been set up by the process, the monitor of the smartphone is projected on the motor vehicle display. The session is monitored, and the algorithm determines whether a performance failure is present. If no performance failure is present, the monitor of the smartphone continues to be projected on the vehicle display.

The algorithm described in DE 10 2015 113 063 A1 ensures a video copy and a monitor copy of the smartphone as external device on the display, by using the optimally qualified physical medium, that is to say the available connection, which is not simply selected by the user.

From DE 11 2012 007 031 T5, an information processing device is known. The device has an operating region acquisition unit, which performs an image analysis on a monitor of a touch panel display. On the monitor of the touch panel display, the content of a monitor of a mobile terminal is displayed by means of a display control unit. The operating region acquisition unit comprises operating region information for identifying a touch-based operating region, corresponding to the monitor of the terminal.

Moreover, a touch-based operating information acquisition unit is disclosed, which detects a touch-based operation on the display and determines the positional information of the touch-based operation, which is detected based on the region information. In addition, a coordinate transformation unit is described, which, based on the region information determined by the unit, transforms positional information of the touch-based operation into positional information corresponding to the monitor of the terminal. As a result, the terminal is operated remotely by an operation/control information communication unit, which sends the transformed positional information to the terminal as remote operation information.

From DE 20 2015 005 533 U1, an infotainment expansion module is known. The infotainment expansion module comprises a processor and/or a hardware decoder for decoding video signals and audio signals, including an API for connection to preconfigured IVI systems, and a storage unit which enables the data exchange between a preconfigured IVI system and an external device, in that the predefined software interface of the external device is transferred into the software interface on the preconfigured IVI system. The IVI system is connected via a wired interface or a radio interface. The infotainment expansion module is designed and produced in the form of a device of the entertainment industry, which meets important vehicle standards such as temperature range and vehicle power supply.

### SUMMARY

By means of the systems known from the prior art, it is not possible to obtain from the car operating systems information as to which applications the vehicle driver uses, which inputs the vehicle driver performs, or which selection has been made by the vehicle driver. For the acquisition of this information, interfaces with the car operating systems implementing the coupling between an external device and a control unit in the vehicle are needed, which are not provided by the manufacturers of the applications or are provided only at high price.

Such information can be used in order to assist the vehicle driver during the driving of the motor vehicle and in order to provide the vehicle driver with additional possibilities or instructions. With the aid of information on the travel destination and thus on a distance from the desired destination, it is possible, for example, to provide the vehicle driver with instructions concerning a gas station, or charging station in the case of electrically operated vehicles, which can be reached within a maximum distance. In addition, information on current gas station or charging station prices along the route can also be displayed, in some cases with an evaluation based on the most advantageous offer.

In addition, it is also provided to transfer the travel destination selected on the external device to the control unit of the motor vehicle. Thereby, vehicle assistance system can assist the vehicle driver in reaching the destination and enable an autonomous or semi-autonomous driving of the motor vehicle. As a result, it is also possible, for example, to check or provide offers from a ride sharing center.

Thus, there is a need for information which so far has only been available internally in a car operating system.

The aim of the disclosure is to indicate a method for recognizing software applications and user input, by means of which recognition of a software application currently implemented by the user as well as input that has been made is made possible without additional interfaces provided by manufacturers of car operating systems.

The aim is achieved by a method having the features of the independent claim. Developments are indicated in the dependent claims.

Here, it is provided to represent the video signals, which have been sent by a mobile terminal, also referred to as an external unit, such as a smartphone, and which have been decoded in a signal decoder associated with a control unit, via an appropriate display in a motor vehicle. Such a control unit arranged in a motor vehicle can be a vehicle infotainment system, for example, which comprises a display suitable for the representation of image information and video information.

The decoded video signals are subjected, simultaneously with the representation thereof on a display, to a first analysis or data analysis. In the first analysis, for example, an image comparison with images of different known software applications, also referred to as “Application software” or abbreviated “Apps,” which are stored in a prepared database, is carried out. Since the method is not limited only to video data, alternatively a comparison with known symbols or a text recognition can also be carried out. From the analyses, a conclusion can be drawn as to the software application currently running on the mobile terminal, such as the smartphone, which is connected to the control unit.

According to development of the disclosure, the data transmitted by the control unit to the external unit such as the smartphone via a feedback channel is examined in a second analysis. Such data has its origin in inputs of the vehicle driver or in feedback of the control unit itself. If two selection possibilities are given to the vehicle driver, for example, by means of the software application running on the external unit such as the smartphone, it is possible to determine, via an analysis of the data of the feedback channel, which selection the vehicle driver has made. Thus, additional information can be obtained by the analysis of the data of the feedback channel.

It is particularly advantageous if the results of the first and of the second analysis are linked to one another. If, in the first analysis, a currently implemented software application can be detected, then, for example, a list of input possibilities or selection possibilities concerning this application can be provided for the comparison for the second analysis.

The accuracy can be improved advantageously in that a concrete monitor representation of a software application is detected in the first analysis, by means of which, for example, a conclusion that there is a limited selection or input possibility on this monitor representation can be drawn.

Thus, for the second analysis, for example, a specification of the inputs to be expected, which is limited to three selection possibilities, can be provided. Thus, in the second analysis of the data of the feedback channel, a recognition of the current input of the vehicle driver can occur more rapidly and more reliably.

According to an advantageous design of the disclosure, in the first analysis, an image comparison occurs between a comparison image currently represented on the display and several images stored in a prepared database. In the database, information on a software application to which the respective images belong is also stored.

A preferred design of the disclosure consists in performing a comparison of symbols represented on the display actuated by the control unit.

In an alternative embodiment of the disclosure, it is provided to carry out a text recognition, abbreviated “OCR,” in the first analysis. In the process, an automated text recognition is carried out within images which are displayed on the display. The recognized words or word groups are compared to words or word groups stored in a prepared database. If an agreement is found, an association with the software application currently used by the vehicle driver occurs via the association of the words or word groups with special software applications, is also stored in the database.

In summary, the method according to the disclosure has the advantage that, by means of the method, the video signals of the external unit such as the smartphone, and the data of the touchscreen control in the infotainment system are analyzed and thereby a conclusion as to a running software application is reached.

The data of the touchscreen control is combined with the current touchscreen inputs in order to determine therefrom which inputs have been carried out on the touchscreen.

The information extracted by the method with regard to the running software application and the inputs performed is output by the method and can be used, for example, in an additional control unit of the motor vehicle for providing additional information for the vehicle driver, which is in connection with a software application used by the vehicle driver and recognized in accordance with the method.

### BRIEF DESCRIPTION OF THE DRAWING

FIG. 1 illustrates a flowchart exemplifying the method according to an exemplary embodiment.

### DETAILED DESCRIPTION

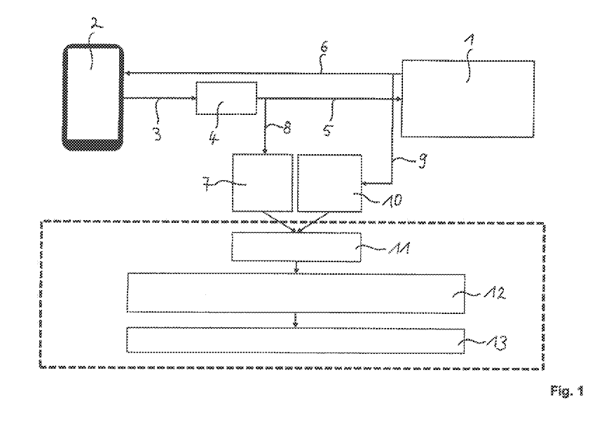

Additional details, features and advantages of designs of the disclosure result from the following description of an embodiment example in reference to the associated drawing. FIG. 1 shows a basic representation of an arrangement for implementing the method for recognizing software applications and user inputs.

FIG. 1 illustrates a flowchart exemplifying the method according to an exemplary embodiment.

A control unit 1 designed as a vehicle infotainment system is connected to an external unit 2 for the data transfer. The data connection can occur, for example, by wire connection via a USB cable or wirelessly via Bluetooth.

In the FIGURE, this data connection is represented by means of a first connection channel 3, a second connection channel 5 and a third connection channel 6. The connection channels 3, 5 and 6 can be formed as cable connection or wire connection. In the case of a wireless connection between the control unit 1 and the external unit 2, at least the first connection channel 3 and the third connection channel 6 are not formed as a wire or as a cable. The term connection channel here relates generally to a connection for data transfer between the corresponding subassemblies.

Via the first connection 3, data, for example, video data, is transmitted to a signal decoder 4 arranged in the control unit 1 or externally. This data can be video data coded according to the video compression standard H.264/MPEG-4, which is decoded in the signal decoder 4. After the decoding, the video data is transmitted via the first connection channel 5 to the control unit 1.

The control unit 1 sends the video data received to a connected display, which is not represented in the FIGURE, on which the video data is represented. The disclosure is here not limited to the transfer and processing of video data. Alternatively, image data, sound data or text data can be transferred.

If such a coupling between the control device 1 and the external device 2 is implemented, for example, using a special car operating system such as “CarPlay,” it is possible, among other possibilities, to operate the smartphone as external unit 2 via the vehicle information system 1. In this way, for example, the navigation, the sending and receiving of messages and the playing of music can be controlled. In such couplings, software applications such as the “Apps” which enable navigation or a reproduction of sound data or video data, are implemented on the smartphone as external unit 2.

An advantage consists in that software applications can also be installed and/or updated in the usual manner on the smartphone as external unit 2. Thus, it is possible to use the constantly expanding possibilities, for example, of the smartphones, without having to make substantial changes in the control unit 1 of the motor vehicle. In addition, the possibility exists that a user can use his desired applications in different motor vehicles.

In the case of the use of “CarPlay” for coupling an external unit 2 to the control unit 1 of a motor vehicle, it is possible, for example, for a control of a software application implemented on the smartphone as external unit 2 to occur both via the voice recognition software “Siri” and also via conventional operating units such as a touchscreen as central display device and input device, special controllers, radio keys and/or steering wheel keys. The feedback or information generated by a user or the control unit 1 is transmitted by the control unit 1 via the third connection 6 to the external unit 2.

The data decoded by the signal decoder 4 is delivered to a first analysis unit 7 via a fourth connection 8. In addition, it is possible to provide that the feedback or information transmitted to the external unit 2 by the control unit 1 is transmitted via a fifth connection 9 to a second analysis 10.

The first analysis unit 7 analyzes the data provided by the signal decoder 4 to determine the content of the data. For this purpose, in the first analysis unit 7, an image recognition or symbol recognition can be carried out, in which images or symbols are compared with images or symbols stored in a database. In the database, additional information can be stored, concerning the applications to which the stored images or symbols belong. Such a database with corresponding assignments to different software applications first has to be generated at least once before executing the method. Updating and expansion of the database are provided.

If a corresponding image or symbol is recognized by the first analysis unit 7, an assignment to a navigation application on the smartphone as external unit 2 occurs.

In an alternative embodiment, the first analysis unit 7 can perform an OCR text recognition. “OCR” here stands for “Optical Character Recognition.” By means of a comparison of the recognized words or text blocks with the data stored in the database, an assignment to different applications occurs, wherein, for example, in conclusion an assignment to an E-mail application is made.

Moreover, the method provides for analyzing not only the data transmitted in a so-called forward channel via the first connection 3 and the second connection 5, but also the data transmitted via the third connection 6 in the feedback channel. For this purpose, a second analysis unit 10 is arranged and connected via the fifth connection 9 to the feedback channel, that is to say to the output of the control unit 1. Via the third connection 6 as feedback channel, inputs of the vehicle driver or chosen selection possibilities are transmitted to the external unit 2.

These inputs or this selection can be carried out by the vehicle driver via the usual input possibilities such as a touchscreen, operating buttons arranged in the area of the center console or of the dashboard, as well as keys on the steering wheel, and the like. In addition, voice inputs are also possible, which is transmitted via the third connection 6 to the smartphone as external unit 2.

The second analysis unit 10 can thus detect an input or a selection of the vehicle driver. If the information of the two analysis units 7, 10 is combined, more information or information with improved content can be recognized.

For the case in which a representation of a surface of a navigation application was detected by the first analysis unit 7, on the basis of an image comparison or a recognition of associated symbols, which makes available a selection of different routes to a travel destination that has been input, an input detected by the second analysis unit 10 can be associated with one of the selection possibilities on a touch-sensitive surface of a display. This information extracted for one or more data streams via the connection channels 5, 6 is stored in the method and provided for output via an appropriate interface.

In order to be able to recognize such information and relationships, the method provides three phases 11, 12, 13 in which the data detected by the first analysis unit 7 and/or by the second analysis unit 10 can be analyzed, evaluated and processed accordingly.

In an analysis phase 11, a recognition of the data and contents transmitted by the external unit 2 to the control unit 1 occurs. In addition, a recognition of inputs and of a selection made by the vehicle driver occurs.

In a subsequent evaluation phase 12, relationships are recognized or established and a conclusion is drawn regarding a concretely used software application, which is displayed or mirrored by the external unit 2 on the display of the control unit 1. In addition to the analysis of the data by means of an image comparison or a symbol comparison and/or a text recognition using a prepared database, the extracted data and analysis results are stored.

Due to the preceding recognition of a running application and the possible selection or input possibilities thereof, the method is prepared in the subsequent implementation phase 13 for the reactions of the vehicle driver who performs an input or a selection. The information of the feedback channel can be recognized, assigned accordingly, and stored.

The interactions of the vehicle driver are recognized, without requiring an additional interface for data exchange with a car operating system. Subsequently, this extracted information can be provided, for example, in order to offer or take on a vehicle navigation. In addition, travel ranges can be determined and offers for tanking or charging the vehicle along the selected route can be proposed. In the same way, connections with external service providers or applications are possible, such as a ride-sharing center, in order to offer an opportunity for ride sharing there.

The extracted information can also be processed further in vehicle systems which make semi-autonomous or autonomous driving of the motor vehicle available to the vehicle driver.

The disclosure thus enables a context-based control of additional systems and subassemblies. In addition, it is provided to use the method with a human-machine interface (HMI).

1. A method for inputs from data associated with an application being executed on an electronic device coupled to a motor vehicle, comprising:
connecting the electronic device to an interface of the motor vehicle;
allowing data to be transferred from the electronic device to the interface, and from the interface to the electronic device;
capturing at least one image associated with a display associated with the data; and
performing an analysis on the at least one image to determine available inputs associated with the data.

2. The method according to claim 1, further comprises recording interactions with the interface in response to the at least one image being displayed on the interface, and communicating the interactions to the electronic device.

3. The method according to claim 1, wherein the performing of the analysis further comprises recognizing images from the data transferred.

4. The method according to claim 1, wherein the performed analysis further comprises performing a symbol recognition of the data transferred.

5. The method according to claim 1, wherein the performed analysis further comprises performing a text recognition of the data transferred.
